(19) United States
(12) Patent Application Publication
(10) Pub. No.: US 2016/0162925 A1
(43) Pub. Date: Jun. 9, 2016

(54) DYNAMICALLY OFFERING A COMPETING PRICE DURING PURCHASING

(71) Applicant: eBay Inc., San Jose, CA (US)

(72) Inventor: Neelakantan Sundaresan, Mountain View, CA (US)

(21) Appl. No.: 14/560,949

(22) Filed: Dec. 4, 2014

(51) Int. Cl. G06Q 30/02

(52) U.S. Cl. CPC G06Q 30/0222

(57) ABSTRACT

The present disclosure is directed to providing a competitive price to a buyer during the purchase process for a good or service obtainable via a publication platform. The publication platform maintains an index of competitors' websites that offer the same good or service. A price probe is periodically and/or dynamically performed on these stored websites to determine whether a competitor is offering a given good or service at a lower price. Where it is determined that a competitor's price is “better” for the given good or service (e.g., lower than the current purchasing price), a message is communicated to the seller of the given good or service that a competitor is offering the given good or service at the lower price. The seller may then be offered the opportunity to lower the current purchase price of the given good or service.

### TECHNICAL FIELD

The present application relates generally to the technical field of data processing and the interactive presentation of data.

### BACKGROUND

A publication network may publish information about items. A publication platform such as an online marketplace, for example, may be paid a percentage of the purchase price of items published for sale via the platform and may seek to optimize data presentation accordingly.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 illustrates a network architecture in accordance with an example embodiment.

FIG. 2 illustrates applications, in accordance with an example embodiment, executable by one or more application servers.

FIG. 3 illustrates a client machine in accordance with an example embodiment.

FIG. 4 is a block diagram illustrating components of an application server, according to an example embodiment, having various components for dynamic competitive pricing.

FIG. 5 is a graphical user interface, in accordance with an example embodiment, for completing the purchase of a good offered by a seller.

FIG. 6 is the graphical user interface of FIG. 5 further displaying a message, in accordance with an example embodiment, informing the buyer that the good being purchased has the lowest known price.

FIG. 7 illustrates messages, in accordance with example embodiments, that may be displayed to a seller when one or more competitors are offering the good being purchased at a lower price.

FIG. 8 is the graphical user interface of FIG. 5 further displaying a second message, in accordance with an example embodiment, informing the buyer that he or she has been selected to receive a lower price for a good being purchased.

FIG. 9 is the graphical user interface of FIG. 5 with the initial price of the good being purchased having been replaced with a lower price.

FIGS. 10A-10B illustrate a method, in accordance with an example embodiment, for dynamically determining and selecting a competitive price for an offered good.

FIG. 11 is a block diagram illustrating components of a machine, according to some example embodiments, able to read instructions from a machine-readable medium and perform any one or more of the methodologies discussed herein, according to aspects of the disclosure.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

The present disclosure provides a network architecture and publication platform for publishing information about items and/or services. In one embodiment, the disclosed network architecture and publication platform provides information about goods and/or services purchasable by potential buyers. In addition, the disclosed network architecture and publication platform provides a competitive price to a buyer during a purchase process for a good or service being offered by a seller. For each good or service being offered for sale, the network architecture and/or publication platform may maintain an index of competitors (e.g., one or more Uniform Resource Locators (“URLs”) of competitors' websites) that offer the same good. The By maintaining a competitive index of similarly offered goods and/or services, the network architecture and/or publication platform can be dynamically configured to perform a price probe on the similarly offered goods and services. This dynamic configuration allows the network architecture and/or publication to determine whether a competitor is offering a given good or service at a lower price than the purchasing price of the given good or service at a configurable time during the purchase process (e.g., when the price probe is performed is configurable). Where it is determined that a competitor's price is “better” for the given good or service (e.g., less than the current purchasing price), a message may be communicated to the seller of the given good or service that a competitor is offering the given good or service at the lower price. The seller may then be offered the opportunity to lower the current purchase price of the given good or service. Alternatively, where it is determined that the current purchase price is better than the competitors' prices, the buyer and/or the seller may be informed accordingly. In this way, the disclosed systems and methods facilitate transactions between buyers and sellers and help consummate purchases that would have otherwise gone abandoned.

The methods or embodiments disclosed herein may be implemented as a computer system having one or more specially-configured modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to execute the instructions.

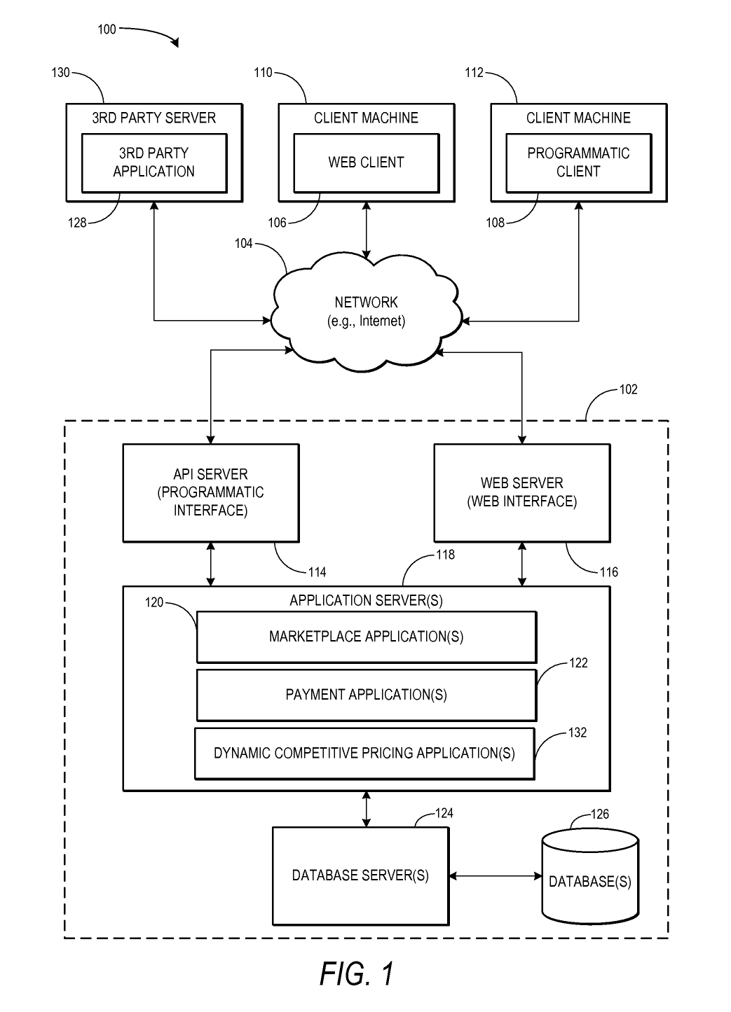

FIG. 1 illustrates a network architecture 100 in accordance with an example embodiment. A networked system 102, in the example forms of a network-based marketplace or publication system, provides server-side functionality, via a network 104 (e.g., the Internet or a Wide Area Network (WAN)) to one or more client machines. FIG. 1 illustrates, for example, a web client 106 (e.g., a browser, such as the Internet Explorer browser developed by Microsoft Corporation of Redmond, Washington State) and a programmatic client 108 executing on respective client machines 110 and 112.

An API server 114 and a web server 116 are coupled to, and provide programmatic and web interfaces respectively to, one or more application servers 118. The application servers 118 host one or more applications, such as a marketplace application(s) 120, a payment application(s) 122, and one or more dynamic competitive pricing communication application(s) 132. The application servers 118 are, in turn, shown to be coupled to one or more database servers 124 that facilitate access to one or more databases 126.

The marketplace application(s) 120 may provide a number of marketplace functions and services to users who access the networked system 102. The payment application(s) 122 may likewise provide a number of payment services and functions to users. The payment application(s) 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace application(s) 120.

The application server 118 may also include one or more dynamic competitive pricing application(s) 132 to determine whether a good or service being purchased is being offered by one or more competitors at a lower price. In one embodiment, the dynamic competitive pricing application(s) 132 determine whether the one or more competitors are offering a lower price on the given good or service at a predetermined time in the purchasing process of the given good or service. For example, the dynamic competitive pricing application(s) 132 may perform this determination after a potential buyer has provided payment details for purchasing the given good or service, but before the buyer has confirmed that he or she desires to complete the purchase of the given good or service.

In one embodiment, the dynamic competitive pricing application(s) 132 maintains an index of websites for competitors. The stored websites may be associated with various goods and services being offered via the marketplace application(s) 120, and a URL for a competitor's good or service may be associated with one or more of the offered goods and services. Thus, when a potential buyer desires to purchase a good and/or service being offered via the marketplace application(s) 120, the dynamic competitive pricing application(s) 132 may reference the association to determine which competitor websites are associated with the good and/or service, and then determine the prices being offered by the competing websites. Thus, when a potential buyer is ready to make a purchase, the dynamic competitive pricing application(s) 132 assures the buyer that he or she is being offered the lowest known price.

While the marketplace application(s) 120, the payment application(s) 122, and the dynamic competitive pricing application(s) 132 are shown in FIG. 1 to form part of the networked system 102, it will be appreciated that, in alternative embodiments, the applications 120, 122, 132 may be separate or distinct from the system 102. For example, the payment application(s) 122 may form part of a payment service that is separate and distinct from the networked system 102.

Further, while the system 100 shown in FIG. 1 employs a client-server architecture, the embodiments are, of course not limited to such an architecture, and could equally well find application in a distributed, or peer-to-peer, architecture system, for example. The marketplace application(s) 120, the payment application(s) 120, and the dynamic competitive pricing application(s) 132 could also be implemented as standalone software programs, which do not necessarily have networking capabilities.

The web client 106 may access the marketplace application(s) 120, the payment application(s) 122, and the dynamic competitive pricing application(s) 132 via the web interface supported by the web server 116. Similarly, the programmatic client 108 may access the various services and functions provided by the applications 120, 122, 132 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, payment, or advertising functions that are supported by the relevant applications of the networked system 102.

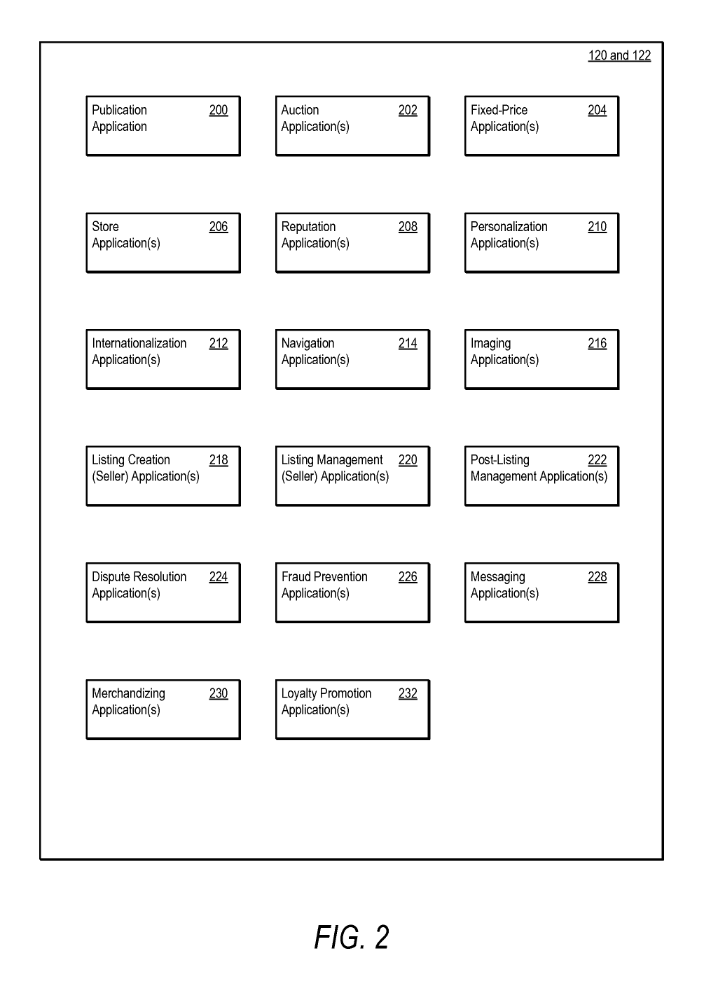

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. FIG. 2 illustrates applications, in accordance with an example embodiment, executable by one or more application server(s) 118. To this end, the marketplace and payment applications 120 and 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (e.g., through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page on which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may, accordingly, include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make the listings available via the networked system 102 as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such as, for example, messages advising users regarding the status of listings at the networked system 102 (e.g., providing “outbid” notices to bidders during an auction process or to providing promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

Furthermore, and referring back to FIG. 1, the dynamic competitive pricing application(s) 132 may leverage one or more of the applications 200-232 in determining the current listing price of a given good and/or service or the prices for the same, or comparable, goods and/or services being offered by competitors. As the dynamic competitive pricing application(s) 132 may be integrated (e.g., directly or indirectly) with the application server 118, the dynamic competitive pricing application(s) 132 may leverage the data obtained from the applications 200-232 to display determine whether to inform a seller about a potential price differential should a competitor offer a given good or service at a lower price. This integration may further extend to the one or more database server(s) 124 and/or database(s) 126 in communication with the application server(s) 118. As discussed below, the dynamic competitive pricing application(s) 132 may access stored information to retrieve competitors' prices, competitor URLs, URLs for goods and/or services offered by competitors, and other such competitor and/or pricing information.

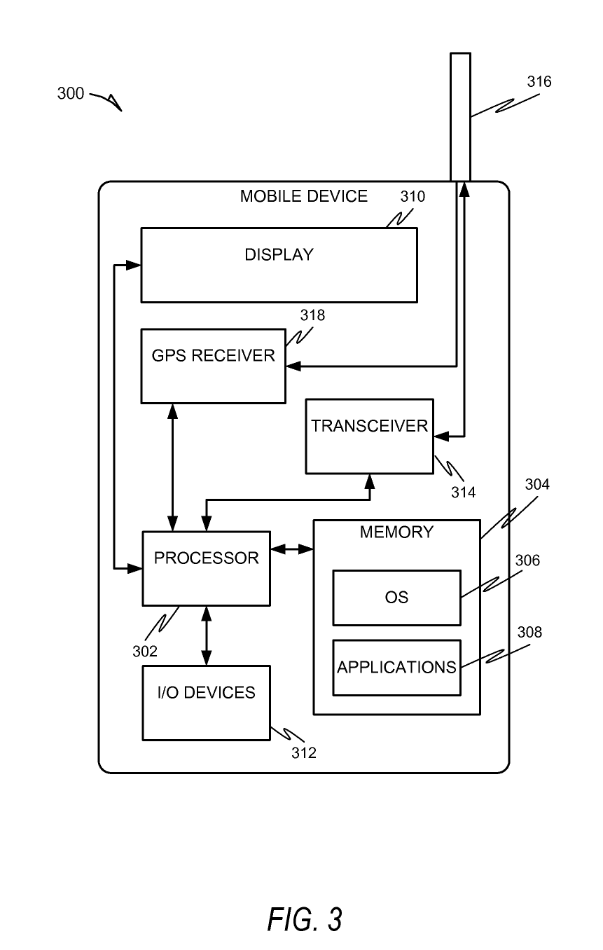

FIG. 3 illustrates a client machine 110 in accordance with an example embodiment. In one embodiment, the client machine 110 is a mobile device 300. The mobile device 300 includes one or more processors 302. The one or more processors 302 may be any of a variety of different types of commercially available processors suitable for mobile devices (e.g., an ARM architecture microprocessor, a Microprocessor without Interlocked Pipeline Stages (MIPS) architecture processor, or another type of processor). A memory 304, such as a random access memory (RAM), a Flash memory, or other type of memory, is typically accessible to the one or more processors 302. The memory 304 may be adapted to store an operating system (OS) 306, as well as application programs 308, such as a mobile location enabled application that can provide location-based services to a user. The one or more processors 302 is coupled, either directly or via appropriate intermediary hardware, to a display 310 and to one or more input/output (I/O) devices 312, such as a keypad, a touch panel sensor, a microphone, and the like. Similarly, in some embodiments, one or more processors 302 is coupled to a transceiver 314 that interfaces with an antenna 316. The transceiver 314 may be configured to both transmit and receive cellular network signals, wireless data signals, or other types of signals via the antenna 316, depending on the nature of the mobile device 300. Further, in some configurations, a GPS receiver 318 may also make use of the antenna 316 to receive GPS signals.

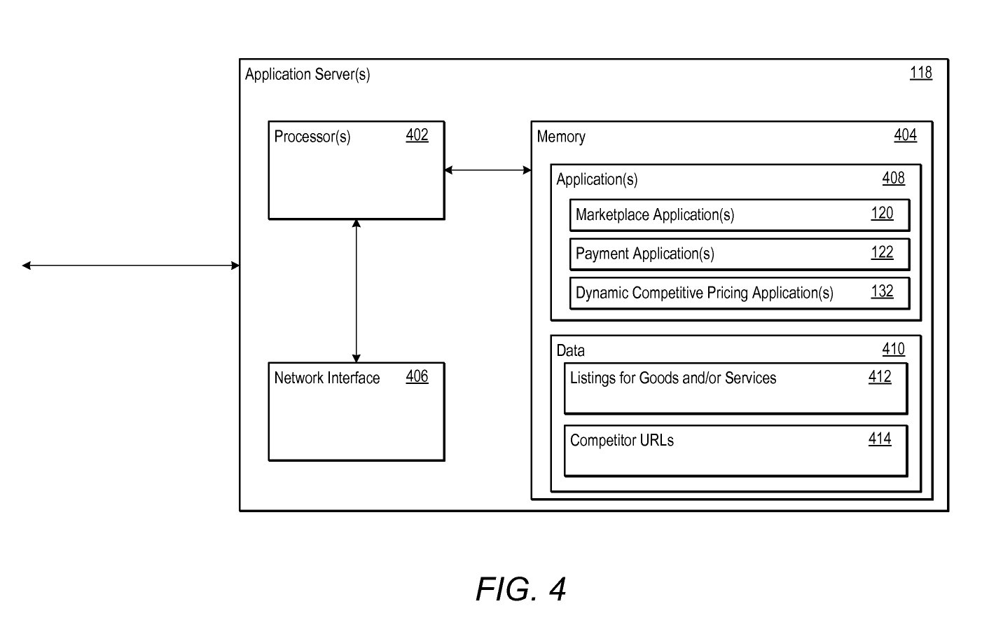

FIG. 4 is a block diagram illustrating components of an application server, according to an example embodiment, having various components for dynamic competitive pricing. As shown in FIG. 4, the application server(s) 118 may include one or more processors 402, a non-transitory, computer-readable memory or collection of such memories 404, and a network interface 406. The network interface 406 may facilitate communications between the application server(s) 118 and any of the other machines shown in FIG. 1.

The memory 404 may include one or more applications 408 and data 410 to support applications 408. The applications 408 may include the one or more marketplace application(s) 120, the one or more payment application(s) 122, and the one or more dynamic competitive pricing application(s) 132. The data 410 may be accessed or used by the one or more applications 508, such as the one or more dynamic competitive pricing application(s) 132. Although the data 510 is shown as being housed within the same block as the dynamic competitive pricing application(s) 132, the data 510 may be housed or stored in other locations, such as the database(s) 126, and accessed via an intermediary machine, such as the database server(s) 124.

The dynamic competitive pricing application (s) 132 may include one or more applications that facilitate dynamically determining whether a competitor's price for a given good or service is better (e.g., lower) than a current price for a given good or service about to be purchased by a potential buyer. In one embodiment, the dynamic competitive pricing application(s) 132 monitor the listings of goods and services offered via the marketplace application(s) 120 and, when a potential buyer reaches a predetermined point in the purchasing process for a given listing, the dynamic competitive pricing application(s) 132 determine whether one or more competitors offer a lower price for the good or service about to be purchased and to inform the seller accordingly.

The dynamic competitive pricing application(s) 132 may store and/or retrieve information from various data stores, such as the listings for goods and/or services data store 412 and/or a competitor URL store 414. The goods and/or services data store 412 may maintain information about the goods and services offered via the marketplace application(s) 120, including whether a potential buyer is contemplating confirming the purchase of a given good or service, and the competitor URL data store 414 may store an index of competitor URLs along with associations between the competitor URLs and the listings offered via the marketplace application(s) 120.

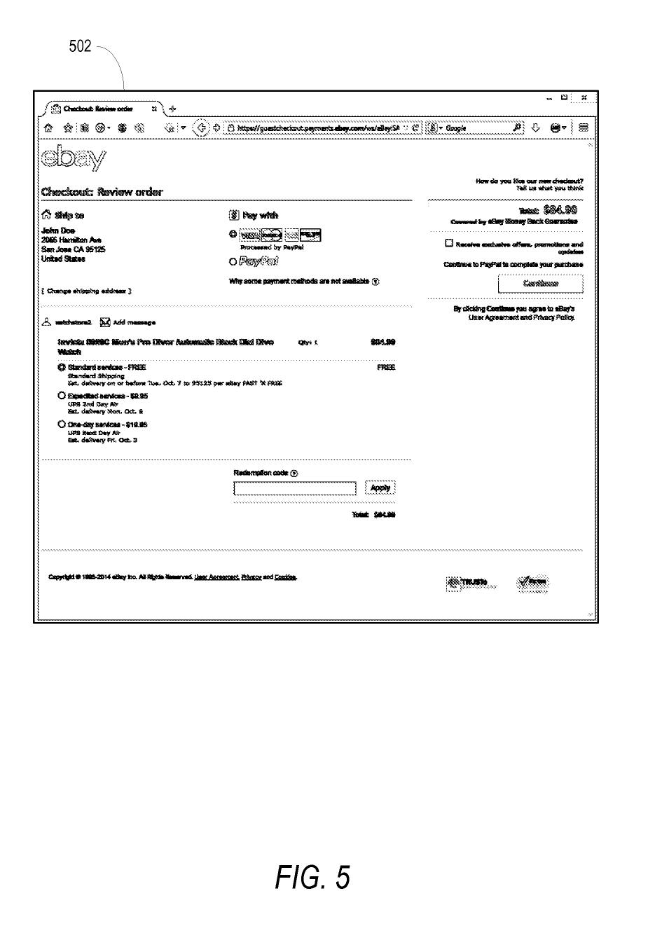

FIG. 5 is a graphical user interface 502, in accordance with an example embodiment, for completing the purchase of a good offered by a seller. As shown in FIG. 5, a user (“John Doe”) is about to confirm the purchase of a watch at a purchase price of $84.00, which is the current price of the watch being offered by the seller. At this point in the purchasing process, the dynamic competitive pricing application(s) 132 determines whether competitors offering the same good for sale are also offering it at a lower price.

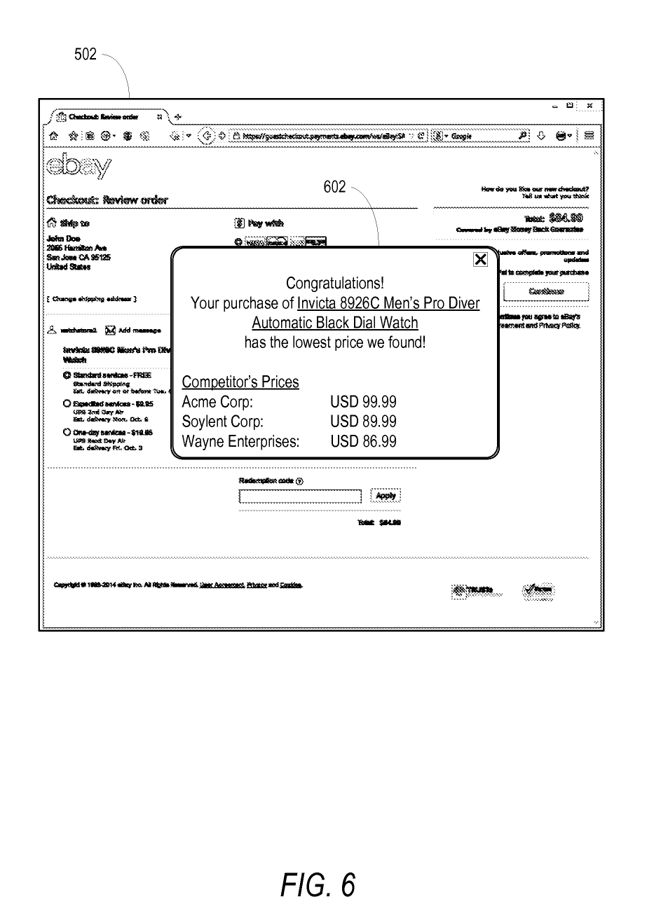

Should the current price being offered by the seller be the lowest price, the dynamic competitive pricing application(s) 132 may inform the potential buyer accordingly. FIG. 6 is the graphical user interface 502 of FIG. 5 further displaying a message 602, in accordance with an example embodiment, informing the buyer that the good being purchased has the lowest known price. In FIG. 6, the dynamic competitive pricing application(s) 132 have determined that the current price of the watch being purchased is the lowest price and have informed the potential buyer accordingly. Furthermore, to assure the buyer that he or she is receiving the lowest known price, the message 602 lists the prices for the same watch being offered by competitors. In one embodiment, each of the prices may be a hyperlink to a URL for a corresponding competitor's webpage that, when selected by the potential buyer, may retrieve the competitor's webpage for the watch being offered by the competitor to demonstrate to the buyer that, in fact, the buyer is receiving the lowest price.

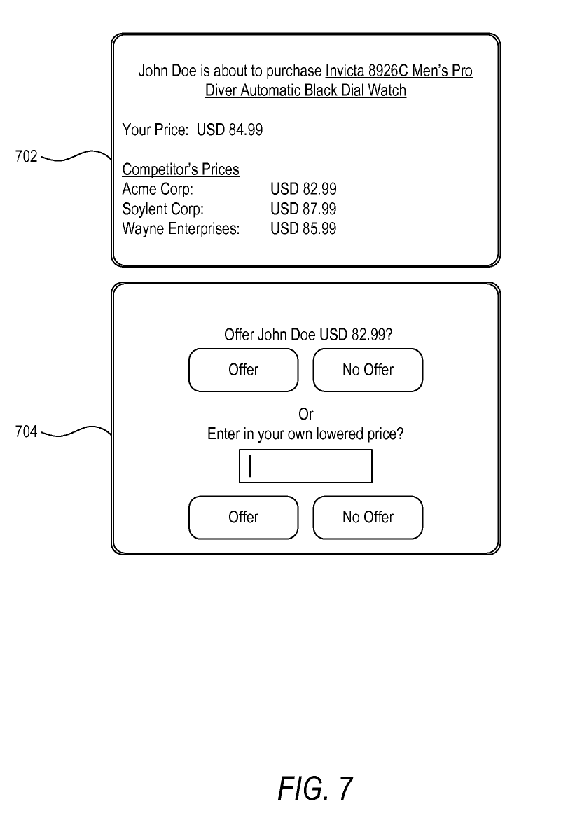

Alternatively, or in addition, should competitors have a price lower than that offered by the seller, the dynamic competitive pricing application(s) 132 may inform the seller accordingly. FIG. 7 illustrates messages 702-704, in accordance with example embodiments, that may be displayed to a seller when one or more competitors are offering the good being purchased at a lower price. Message 702 may include information to the seller about the relevant purchase process including, but not limited to, the user about to complete the purchase, the good or service about to be purchased, the seller's price for the given good and/or service, and the prices for the good and/or service being offered by competitors. In one embodiment, the prices shown in the message 702 may be selectable hyperlinks that, when selected, display a webpage with the competitor's offer for the given good and/or service.

Message 704 may afford the seller the opportunity to confirm that the dynamic competitive pricing application(s) 132 should offer the potential buyer the lowest matching price. Alternatively, or in addition, message 704 may afford the seller the opportunity to provide another price for the good and/or service about to be purchased, so that the seller can provide a lower price than that of competitors to the potential buyer. In this way, the seller can outprice the competition and encourage the buyer to complete the purchase.

In addition, where the potential buyer is in the process of buying multiple items (e.g., more than one item is listed in the purchase order), the dynamic competitive pricing application(s) 132 may be configured to determine whether the prices offered to the potential buyer are the lowest prices offered in the aggregate (e.g., for the entirety of the order) or for each individual item. In this regard, where there are multiple items in an order, each seller of the items may be contacted based on the dynamic competitive pricing application(s) 132 comparing the offered price for a given item with comparable items stored in the competitor index. Where the items listed in the order may arrive in separate shipments (e.g., the items are being shipped from different locations or being sold by different sellers), the dynamic competitive pricing application(s) 132 may use (e.g., add) the shipping costs for each item in determining whether the potential buyer is receiving the best (e.g., the lowest) price for an item when compared with offerings from other competitors.

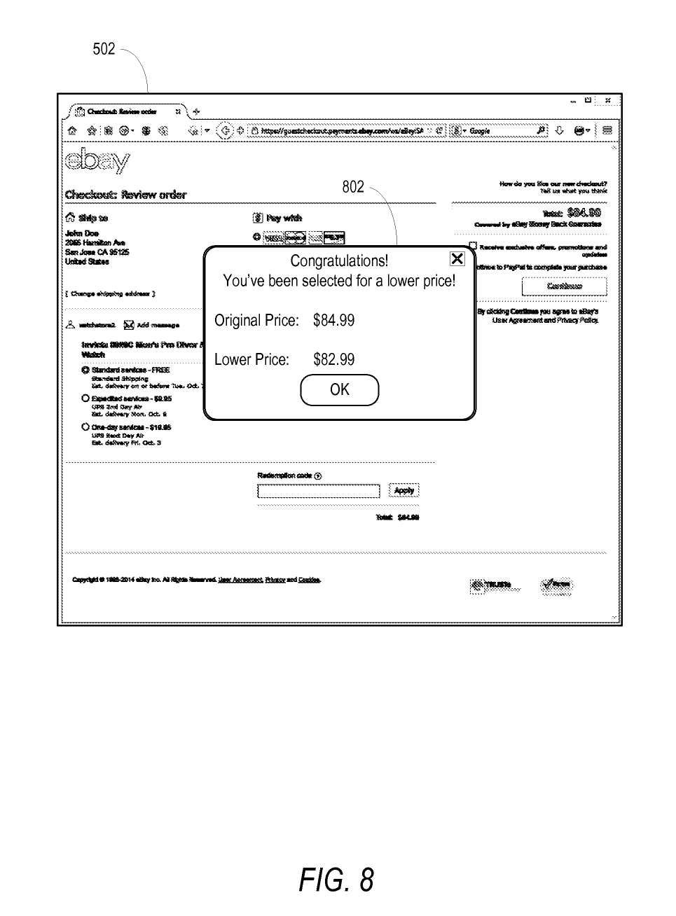

Should the seller confirm that a lowered price should be offered to the buyer, the dynamic competitive pricing application(s) 132 may display a message to the buyer accordingly. FIG. 8 is the graphical user interface of FIG. 5 further displaying a second message 802, in accordance with an example embodiment, informing the buyer that he or she has been selected to receive a lower price for a good being purchased. In the example shown in FIG. 8, the seller has opted to confirm that the buyer should receive the lowest matching price, namely, a price of “$82.99.”

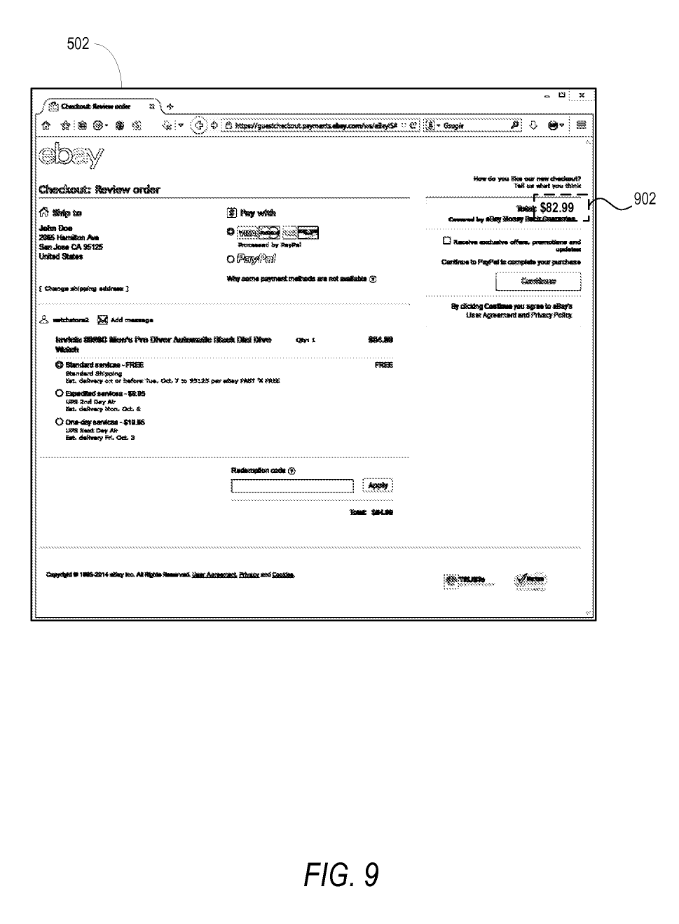

The lower price offered to the buyer may be reflected in the purchasing process. FIG. 9 is the graphical user interface 502 of FIG. 5 with the initial price of the good being purchased having been replaced with a lower price 902. In this way, the buyer can visually confirm that the price has been changed to reflect the lower price and that the congratulatory message 802 of FIG. 8 was correct.

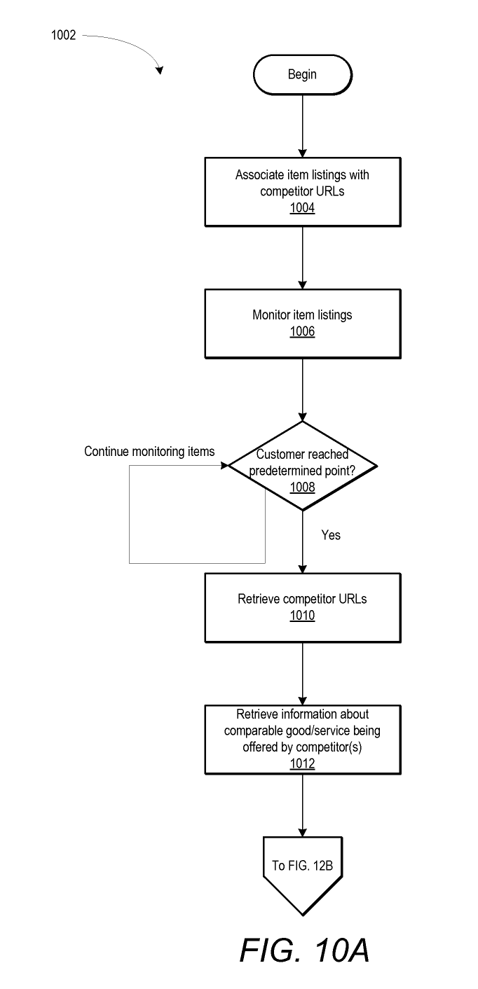

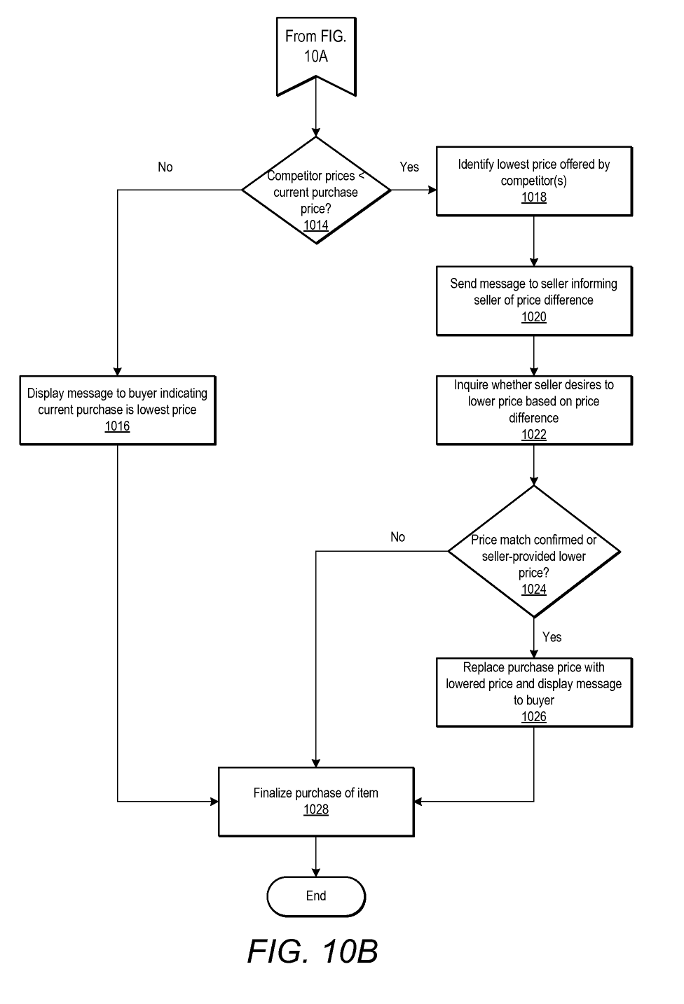

FIGS. 10A-10B illustrate a method 1002, in accordance with an example embodiment, for dynamically determining and selecting a competitive price for an offered good. The method 1002 may be implemented by the application server(s) 120 and, accordingly, is merely described by reference thereto. Initially, and with reference to FIG. 10A, items being offered via the marketplace application(s) 120 are associated with competitor URLs. Alternatively, or in addition, the association with the competitor URLs may include URLs to the same good and/or service being offered by the corresponding competitor. (Operation 1004). The dynamic competition pricing application(s) 132 may then monitor the listings for purchasing activity by potential buyers. (Operation 1006). Should the dynamic competitive pricing application(s) 132 detect that a potential buyer is interested in a particular listing, the dynamic competitive pricing application(s) 132 may monitor to the buyer's purchasing activity to see if the potential buyer reaches a predetermined point in the purchasing process, such as a purchase confirmation stage (Operation 1008).

Where the potential buyer reaches the predetermined point in the purchasing process, the dynamic competitive pricing application(s) 132 may then retrieve the competitor URLs associated with the good and/or service about to be purchased (Operation 1010). The dynamic competitive pricing application(s) 132 may then retrieve information about the same, or comparable, goods and/or services being offered by corresponding competitors (Operation 1012). The retrieved information may further include pricing information about the same, or comparable, goods and/or services.

Referring to FIG. 10B, the dynamic competitive pricing application(s) 132 then determine whether the prices being offered by competitors are better (e.g., lower) than the current price being offered by the seller for the given good and/or service (Operation 1014). Should the current price be lower than competitor prices, the dynamic competitive pricing application(s) 132 may inform the buyer and/or the seller accordingly, such as by displaying a message 602 as shown in FIG. 6 (Operation 1016). The dynamic competitive pricing application(s) 132 may then allow the buyer to complete his or her purchase (Operation 1028).

However, should a competitor offer a lower price for the given good and/or service, the dynamic competitive pricing application(s) 132 may first identify which of the prices is the lowest price (Operation 1018). Alternatively, or in addition, the dynamic competitive pricing application(s) 132 may be configured to select a price that is within a configurable degree of tolerance of the lowest price (e.g., fifty cents higher or lower than the lowest price). The dynamic competitive pricing application(s) 132 may then send a message to the seller (Operation 1020) and inquire whether the seller desires to lower the price of the given good and/or service based on the lowest price determined by the dynamic competitive pricing application(s) 132 (Operation 1022). The dynamic competitive pricing application(s) 132 may then receive a decision by the seller of whether to lower the price on the given good and/or service (Operation 1024). If the seller opts not to provide a lower price (e.g., the seller is unable to compete with the lowest price), the dynamic competitive pricing application(s) 132 may allow the buyer to complete his or her purchase (Operation 1028). Alternatively, should the seller decide to lower the price of the given good or service, the dynamic competitive pricing application(s) 132 may inform the buyer and replace the current price of the good and/or service with the lowered price (Operation 1026). As discussed previously, the lowered price may be the lowest price offered by a competitor, a lower price within a degree of tolerance of the lowest price offered by a competitor, a price provided by the seller, or other such lower price. The potential buyer may then complete his or her purchase (Operation 1028).

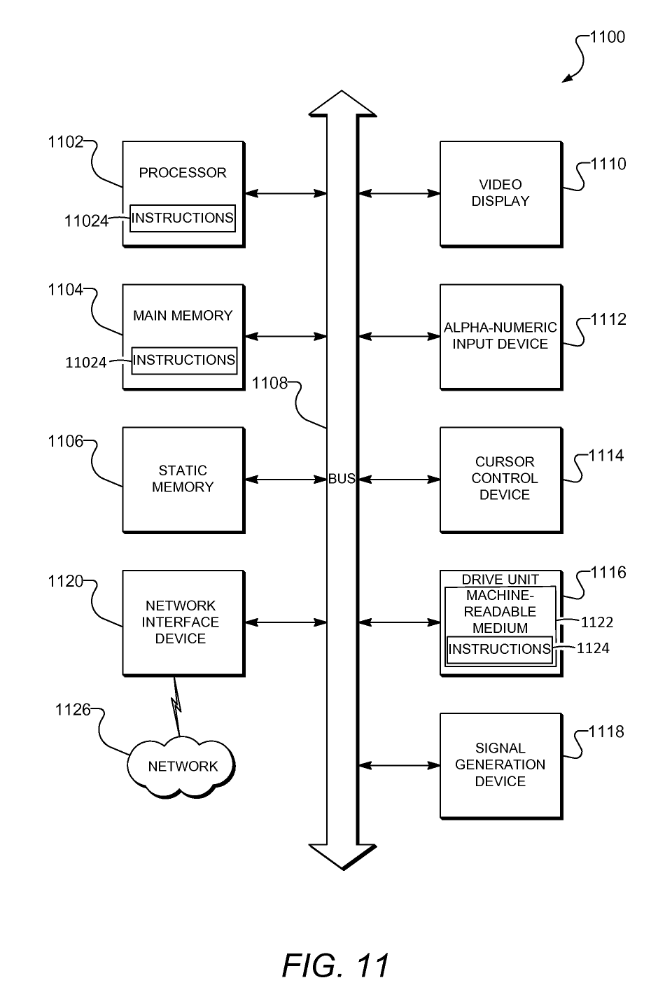

FIG. 11 is a block diagram illustrating components of a machine, according to some example embodiments, able to read instructions from a machine-readable medium and perform any one or more of the methodologies discussed herein, according to aspects of the disclosure. In particular, FIG. 11 illustrates an example computer system 1100 within which instructions 1124 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a user interface (UI) navigation (or cursor control) device 1114 (e.g., a mouse), a disk drive unit 1116, a signal generation device 1118 (e.g., a speaker) and a network interface device 1120.

The disk drive unit 1116 includes a non-transitory machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting non-transitory, machine-readable media. The instructions 1124 may also reside, completely or at least partially, within the static memory 1106.

While the machine-readable medium 1122 is shown in an example embodiment to be a single medium, the term “machine-readable medium” may include a single medium or multiple media (e.g., a centralized or distributed database, and/or associated caches and servers) that store the one or more instructions 1124 or data structures. The term “machine-readable medium” shall also be taken to include any tangible medium that is capable of storing, encoding, or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

In this manner, the disclosed systems and methods provide a mechanism by which a potential buyer can be assured that he or she is receiving the lowest price for a given good or service. Furthermore, the disclosed systems and methods leverage a number of various technologies including database technologies, real-time communications, authentication protocols, comparative analysis algorithms, and other such networking technologies. Accordingly, the disclosed systems and methods involve a technical approach to address the shortcomings of conducting transactions through an electronic marketplace, particularly where there is some ambiguity as to whether a price for a given good or service is comparable to prices being offered by competitors for the same good or service.

Certain embodiments have been described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled.

A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. The foregoing systems and methods may include hardware (e.g., machine) and software architectures that may be deployed in various example embodiments. It is contemplated that any features of any embodiments disclosed herein can be combined with any other features of any other embodiments disclosed herein. Accordingly, these any such hybrid embodiments are within the scope of the present disclosure.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method comprising:
establishing, with one or more processors, a competitor index for a first plurality of goods or services obtainable through a publication platform, the competitor index comprising first information about corresponding goods or services being offered by a first plurality of competitors;
receiving a transaction request obtain a selected one of the first plurality of goods or services;
referencing, in response to the received request, the competitor index to retrieve second information associated with a second plurality goods or services, the second plurality of goods or services being selected based on the purchase request;
comparing a first price associated with the selected one of the first plurality of goods or services with a plurality of prices associated with the second plurality of goods or services, where the plurality of prices is obtained from the second information; and
providing a first message to be displayed to a potential buyer of the selected one of the first plurality of goods or services based on the comparison of the first price and the plurality of prices associated with the second plurality of goods or services.

2. The method of claim 1, wherein the first information comprises corresponding Uniform Resource Locators (“URLs”) for each of the goods or services being offered by the first plurality of competitors.

3. The method of claim 2, further comprising referencing at least one URL to obtain at least one price of the plurality of prices associated with at least one good or service selected from the second plurality of goods or services.

4. The method of claim 1, further comprising causing a second message to be sent to a seller of the selected one of the first plurality of goods or services based on the comparison of the first price and the second price.

5. The method of claim 4, further comprising receiving an instruction from the seller to change the first price associated with the selected one of the first plurality of goods or services.

6. The method of claim 5, wherein the first message to be displayed to the potential buyer comprises the changed first price associated with the selected one of the first plurality of goods or services.

7. The method of claim 1, wherein the request further comprises a request to purchase a third plurality of goods or services selected from the first plurality of goods or services; and the method further comprises:
comparing individual prices of the third plurality of goods or services with the plurality of prices obtained from the second information;
comparing an aggregate price of the third plurality of goods or services with the plurality of prices obtained from the second information; and
providing the first message further comprises providing the first message based on the comparison of the individual prices of the third plurality of goods or services and the comparison of the aggregate price of the third plurality of goods or services.

8. A system comprising:
a non-transitory, computer-readable medium storing computer-executable instructions; and
one or more processors in communication with the non-transitory, computer-readable medium that, having executed the computer-executable instructions, are configured to:
establish a competitor index for a first plurality of goods or services obtainable through a publication platform, the competitor index comprising first information about corresponding goods or services being offered by a first plurality of competitors;
receive a transaction request to obtain a selected one of the first plurality of goods or services;
reference, in response to the received request, the competitor index to retrieve second information associated with a second plurality goods or services, the second plurality of goods or services being selected based on the purchase request;
compare a first price associated with the selected one of the first plurality of goods or services with a plurality of prices associated with the second plurality of goods or services, where the plurality of prices is obtained from the second information; and
provide a first message to be displayed to a potential buyer of the selected one of the first plurality of goods or services based on the comparison of the first price and the plurality of prices associated with the second plurality of goods or services.

9. The system of claim 8, wherein the first information comprises corresponding Uniform Resource Locators (“URLs”) for each of the goods or services being offered by the first plurality of competitors.

10. The system of claim 9, wherein the one or more processors are further configured to reference at least one URL to obtain at least one price of the plurality of prices associated with at least one good or service selected from the second plurality of goods or services.

11. The system of claim 8, wherein the one or more processors are further configured to cause a second message to be sent to a seller of the selected one of the first plurality of goods or services based on the comparison of the first price and the second price.

12. The system of claim 11, wherein the one or more processors are further configured to receive an instruction from the seller to change the first price associated with the selected one of the first plurality of goods or services.

13. The system of claim 12, wherein the first message to be displayed to the potential buyer comprises the changed first price associated with the selected one of the first plurality of goods or services.

14. The system of claim 8, wherein the request further comprises a request to purchase a third plurality of goods or services selected from the first plurality of goods or services; and the one or more processors are further configured to:
compare individual prices of the third plurality of goods or services with the plurality of prices obtained from the second information;
compare an aggregate price of the third plurality of goods or services with the plurality of prices obtained from the second information; and
provide the first message further based on the comparison of the individual prices of the third plurality of goods or services and the comparison of the aggregate price of the third plurality of goods or services.

15. A non-transitory, computer-readable medium storing computer-executable instructions that, when executed by one or more processors, cause the one or more processors to perform a method, the method comprising:
establishing, with one or more processors, a competitor index for a first plurality of goods or services obtainable through a publication platform, the competitor index comprising first information about corresponding goods or services being offered by a first plurality of competitors;
receiving a transaction request to obtain a selected one of the first plurality of goods or services;
referencing, in response to the received transaction request, the competitor index to retrieve second information associated with a second plurality goods or services, the second plurality of goods or services being selected based on the purchase request;
comparing a first price associated with the selected one of the first plurality of goods or services with a plurality of prices associated with the second plurality of goods or services, where the plurality of prices is obtained from the second information; and
providing a first message to be displayed to a potential buyer of the selected one of the first plurality of goods or services based on the comparison of the first price and the plurality of prices associated with the second plurality of goods or services.

16. The non-transitory, computer-readable medium of claim 15, wherein the first information comprises corresponding Uniform Resource Locators (“URLs”) for each of the goods or services being offered by the first plurality of competitors.

17. The non-transitory, computer-readable medium of claim 16, wherein the method further comprises referencing at least one URL to obtain at least one price of the plurality of prices associated with at least one good or service selected from the second plurality of goods or services.

18. The non-transitory, computer-readable medium of 15, wherein the method further comprises causing a second message to be sent to a seller of the selected one of the first plurality of goods or services based on the comparison of the first price and the second price.

19. The non-transitory, computer-readable medium of claim 18, wherein the method further comprises receiving an instruction from the seller to change the first price associated with the selected one of the first plurality of goods or services.

20. The non-transitory, computer-readable medium of claim 19, wherein the first message to be displayed to the potential buyer comprises the changed first price associated with the selected one of the first plurality of goods or services.
